(19) United States
(12) Patent Application Publication
(10) Pub. No.: US 2026/0277127 A1
(43) Pub. Date: Sep. 17, 2026

(54) TONER AND METHOD OF PRODUCING THE SAME

(71) Applicant: SHARP KABUSHIKI KAISHA, Osaka (JP)

(72) Inventor: Yuki HIRANO, Osaka (JP)

(21) Appl. No.: 19/558,803

(22) Filed: Mar. 6, 2026

(30) Foreign Application Priority Data
Mar. 17, 2025 (JP) 2025-042183

(51) Int. Cl. G03G 9/087; G03G 9/08

(52) U.S. Cl. CPC G03G 9/08755; G03G 9/081; G03G 9/08782

(57) ABSTRACT

A toner including a toner particle containing a binder resin and a release agent has the following configuration. The binder resin contains an amorphous polyester resin and a crystalline polyester resin. The amorphous polyester resin includes a hydrophobic site-introduced polyester resin in which a hydrophobic site is introduced into a terminal of a polyester chain. The release agent is a non-polar wax. The difference in SP value between the amorphous polyester resin and the release agent is 1 or more and 2 or less, and the difference in SP value between the crystalline polyester resin and the release agent is 1 or less. When the glass transition temperature of the binder resin is A [° C.] and the glass transition temperature of the toner particle is B [° C.], A-B is 2 or more and 12 or less.

### FIELD OF THE INVENTION

The present disclosure relates to a toner and a method of producing the same.

### BACKGROUND ART

A toner which is used in an electrophotographic image forming device such as a copying machine, a multi-function printer, a printer, or a facsimile device (a toner for developing an electrostatic latent image) generally has a constitution in which an external additive is adherent to the surfaces of toner particles (toner cores).

The toner particles each have a structure in which internal additives such as a colorant and a release agent are dispersed in a binder resin, and as the binder resin, a styrene acrylic resin or a polyester resin is often used.

### SUMMARY

### Technical Problem

As features of both the resins which are often adopted as the binder resin, the styrene-acrylic resin is excellent in wax dispersibility and grindability, and has a small environmental dependency of charging. In contrast, the polyester resin is superior to the styrene-acrylic resin in low-temperature fixability, and is also superior in high glossiness and pigment dispersibility.

In recent years, to cope with environmental problems, there has been a demand for a toner that can be fixed at a low temperature (hereinafter, referred to as a low-temperature fixable toner). As the binder resin of the low-temperature fixable toner, a polyester resin is mainly adopted. However, the polyester resin has a molecular structure as illustrated in FIG. 2, has a high polarity in the molecule, and thus, has low wax dispersibility.

A wax functions as a release agent in the toner during heat fixing, and can improve the low-temperature fixability of the toner. Examples of the wax to be used as the release agent in a pulverized toner include a monoester wax, a polyol wax, and a hydrocarbon wax. Among these, the monoester wax is suitable for a low-temperature fixable toner because it is relatively easily dispersed in the polyester resin, has a low melting temperature, and exhibits sharp thermal melting characteristics, but high-temperature offset resistance and heat-resistant storage stability are deteriorated.

In contrast, the polyol wax and the hydrocarbon wax as the release agent each have a low melting point to be advantageous for low-temperature fixing, and have a low weight loss rate in thermogravimetric measurement (TG) to be excellent in high-temperature offset resistance. However, the polyol wax and the hydrocarbon wax have molecular structures, respectively, as illustrated in FIG. 4, and are non-polar waxes in which polarities are canceled out in the molecule. Accordingly, the waxes have a low affinity with the polyester resin and are hardly miscible with the polyester resin, and thus it is difficult to uniformly disperse the waxes in the polyester resin, and the amount of each of the waxes that can be added as a toner raw material is limited.

FIGS. 1A and 1B are schematic views each illustrating a dispersion state of a release agent in a toner particle, and FIG. 1B illustrates that in a toner T2 in the related art including a polyester resin and a non-polar wax, the non-polar wax is not uniformly dispersed. When the non-polar wax is not uniformly dispersed, a domain W2 of the non-polar wax becomes large, and thus, the fixability and the heat-resistant storage property of the toner are deteriorated. That is, when a combination of a polyester resin, which is a resin having a high polarity in the molecule, and a non-polar wax is adopted in a pulverized toner, there is a problem that the fixability and the heat-resistant storage stability of the toner become insufficient.

The toner and the method of producing the toner of the present disclosure have been found in view of such circumstances in the case of adopting a non-polar wax that is less likely to be dispersed in a polyester resin as a release agent, and a main object thereof is to provide a toner that can sufficiently disperse the release agent in a toner particle and has both fixability and heat-resistant storage stability, and a method of producing the toner.

### Solution to Problem

A toner according to the present disclosure made to solve the above problem is a toner including a toner particle containing a binder resin and a release agent, in which the binder resin contains an amorphous polyester resin and a crystalline polyester resin, the amorphous polyester resin contains a hydrophobic site-introduced polyester resin in which a hydrophobic site is introduced into a terminal of a polyester chain, the release agent is a non-polar wax,
a difference in SP value between the amorphous polyester resin and the release agent is 1 or more and 2 or less,
a difference in SP value between the crystalline polyester resin and the release agent is 1 or less, and
when a glass transition temperature of the binder resin is A [° C.] and a glass transition temperature of the toner particle is B [° C.], A-B is 2 or more and 12 or less.

In the toner, the amorphous polyester resin preferably contains the hydrophobic site-introduced polyester resin in an amount of 15 mass % or more.

In the toner, the hydrophobic site is preferably a polystyrene chain, a polyethylene chain, or a polypropylene chain.

In the toner described above, the non-polar wax is preferably a polyol wax or a hydrocarbon wax.

In the toner described above, the hydrophobic site preferably has 35 or more carbon atoms.

In the toner described above, the release agent in the toner particle preferably has an average dispersion size of 0.04 m or more and 6.0 m or less.

A method of producing the toner includes
a melt-kneading of melt-kneading a mixture of toner raw materials containing the binder resin and the release agent to obtain a melt-kneaded product, and
a shear rate in melt-kneading the mixture in the melt-kneading is preferably 4500 s⁻¹ or more and 25000 s⁻¹ or less.

### Advantageous Effects of Disclosure

The toner and the method of producing the toner according to the present disclosure provide excellent effects such as allowing the release agent to be sufficiently dispersed in the toner particle and allowing both fixability and heat-resistant storage stability to be achieved.

### BRIEF DESCRIPTION OF THE DRAWINGS

FIGS. 1A and 1B are schematic views each illustrating a dispersion state of a release agent in a toner particle.

FIG. 2 is a diagram showing a chemical formula of a polyester resin.

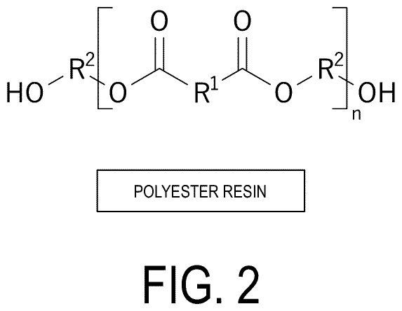

FIG. 3 is a diagram showing examples of a molecular chain corresponding to a hydrophobic moiety by chemical formulas.

FIG. 4 is a diagram showing examples of a wax corresponding to a non-polar wax by chemical formulas.

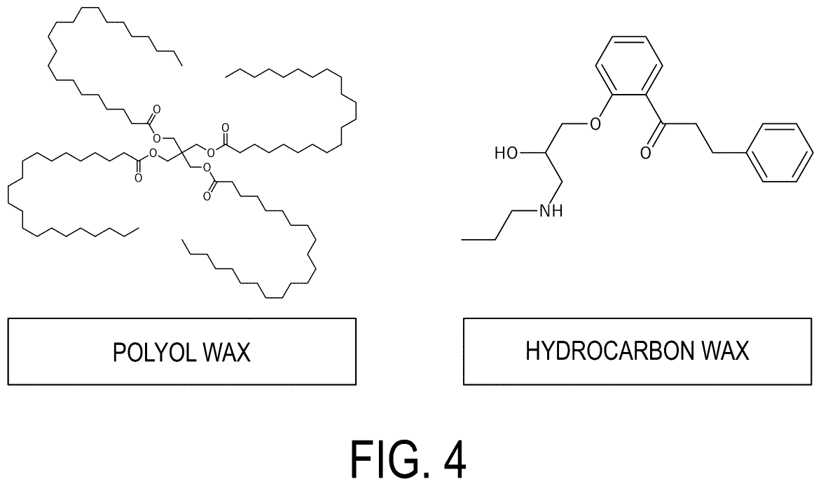

FIG. 5 provides SEM images of cross-sections of toner particles each using a polyol wax as a release agent.

### DESCRIPTION OF EMBODIMENTS

Hereinafter, a toner of the present disclosure and a method of producing the toner will be described. In the present disclosure, “internally added” means that an additive is added in such a manner as to be contained inside an additive-receiving material, and “externally added” means that an additive is added in such a manner as to be adherent to an outer surface (surface) of an additive-receiving material.

### 1. Overall Configuration of Toner

The toner according to the present embodiment is a toner having a toner particle containing a binder resin and a release agent, and satisfies the following requirements (A) to (F).

(A) The binder resin contains an amorphous polyester resin and a crystalline polyester resin.

(B) The amorphous polyester resin contains a hydrophobic site-introduced polyester resin in which a hydrophobic site is introduced into a terminal of a polyester chain.

(C) The release agent is a non-polar wax.

(D) A difference in SP value between the amorphous polyester resin and the release agent is 1 or more and 2 or less.

(E) The difference in SP value between the crystalline polyester resin and the release agent is 1 or less.

(F) When a glass transition temperature of the binder resin is A [° C.] and a glass transition temperature of the toner particle is B [° C.], A-B is 2 or more and 12 or less.

In the present embodiment, regarding the requirement (D), the difference in SP value between the amorphous polyester resin and the release agent is preferably 1.5 or more and 1.9 or less. In addition, regarding the requirement (E), the difference in SP value between the crystalline polyester resin and the release agent is preferably 0.4 or more and 0.8 or less. Furthermore, in the requirement (F), A-B is preferably 3 or more and 10 or less, and more preferably 4 or more and 8 or less.

When the SP value and the glass transition temperature satisfy such a relationship and the requirements (A) to (C) are satisfied, the release agent can be sufficiently dispersed in the toner particle, which makes it possible to realize a toner having both fixability and heat-resistant storage stability.

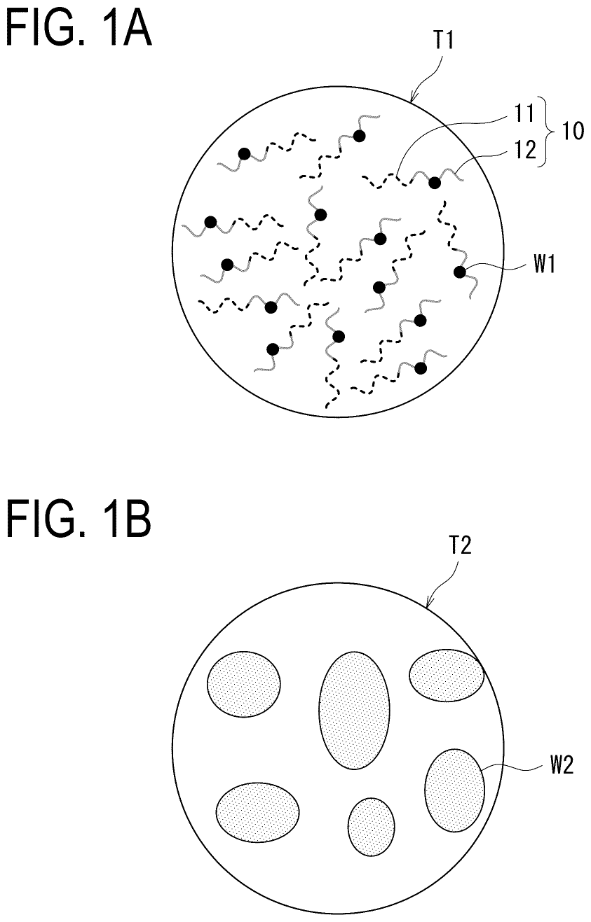

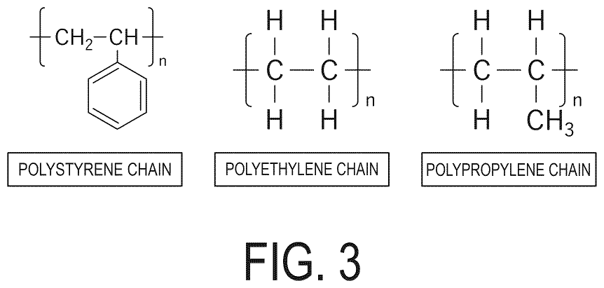

FIGS. 1A and 1B are schematic views each illustrating a state of dispersion of the release agent in the toner particle, and FIG. 1A illustrates that a non-polar wax as the release agent is uniformly dispersed in a toner particle T1 according to the present embodiment. The toner particle T1 according to the present embodiment contains a hydrophobic site-introduced polyester 10 in which a hydrophobic site 12 is introduced into a terminal of a polyester chain 11. The hydrophobic site 12 has a very low polarity in the structure as illustrated in FIG. 3, and has a high affinity with the non-polar wax. Thus, the hydrophobic site 12 functions as a crystal nucleating agent for the non-polar wax, and the non-polar wax is sufficiently dispersed in the toner particle T1, whereby a domain W1 of the non-polar wax becomes smaller than a domain W2 in FIG. 1B. With such a mechanism, by reducing a domain size of the non-polar wax, the toner according to the present embodiment is excellent in high-temperature offset resistance (fixability on the high temperature side of a fixable region) and heat-resistant storage stability.

Next, the toner particle according to the present embodiment and the constituent components of the toner particle will be described.

### 2. Toner Particle (Toner Core)

The toner particle contains a binder resin and an internal additive. The internal additive is dispersed in the binder resin. An external additive is adherent to the surface of the toner particles. The volume-average particle size of toner particles according to the present embodiment can be appropriately selected according to the purpose, but the volume-average particle size is preferably 4 μm or more and 10 μm or less, and more preferably 5 μm or more and 8 μm or less. The glass transition temperature of the toner particle according to the present embodiment is preferably 55° C. or higher and 67° C. or lower and more preferably 60° C. or higher and 65° C. or lower, while satisfying the requirement (F).

In the toner particle according to the present embodiment, the binder resin contains an amorphous polyester resin and a crystalline polyester resin. The amorphous polyester resin includes a hydrophobic site-introduced polyester resin in which a hydrophobic site is introduced into a terminal of a polyester chain. In the present embodiment, the glass transition temperature of the binder resin is preferably 63° C. or higher and 73° C. or lower, and more preferably 65° C. or higher and 70° C. or lower, while satisfying the requirement (F).

### 3. Binder Resin

### Amorphous Polyester Resin

The amorphous polyester resin contained in the toner particles according to the present embodiment is obtained by, for example, a polycondensation reaction between a carboxylic acid monomer including terephthalic acid or isophthalic acid as a main component and a polyhydric alcohol including ethylene glycol as a main component.

The reaction conditions are the same as those for the production of a general polyester resin. For example, the amorphous polyester resin is obtained by reacting a dicarboxylic acid monomer and a polyhydric alcohol at 190° C. to 240° C. in a nitrogen gas atmosphere, in the presence of an esterification catalyst as necessary. The reaction ratio between the polyhydric alcohol and the carboxylic acid monomer is preferably 1.3:1 to 1:1.2 in terms of an equivalent ratio between hydroxyl groups and carboxy groups [OH]:[COOH].

The dicarboxylic acid monomer used for synthesis of the amorphous polyester resin includes terephthalic acid or isophthalic acid as a main component. The mole content of terephthalic acid or isophthalic acid in the dicarboxylic acid monomer is preferably 70% or more and 100% or less, more preferably 80% or more and 100% or less.

The dicarboxylic acid monomer may include an aromatic dicarboxylic acid or an aliphatic dicarboxylic acid other than terephthalic acid or isophthalic acid. Examples of the aromatic dicarboxylic acid other than terephthalic acid or isophthalic acid include fumaric acid. Examples of the aliphatic dicarboxylic acid include adipic acid, sebacic acid, and succinic acid. The dicarboxylic acid monomer may include an ester-forming derivative of terephthalic acid or isophthalic acid, an ester-forming derivative of an aromatic dicarboxylic acid other than terephthalic acid or isophthalic acid, an ester-forming derivative of an aliphatic dicarboxylic acid, or the like. In the present disclosure, ester-forming derivatives include carboxylic acid anhydrides, alkyl esters, and the like. One of these dicarboxylic acid monomers may be used individually, or two or more may be used in combination.

In the synthesis of the amorphous polyester resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

The diol monomer used for synthesis of the amorphous polyester resin includes ethylene glycol as a main component. Here, the mole content of ethylene glycol in the diol monomer is preferably 70% or more and 100% or less, more preferably 80% or more and 100% or less.

The diol monomer may include 1,3-propylene glycol, 1,4-butanediol, and the like. One of these diol monomers may be used individually, or two or more may be used in combination.

### <Hydrophobic Site-Introduced Polyester Resin>

The amorphous polyester resin in the toner particle according to the present embodiment includes a hydrophobic site-introduced polyester resin in which a hydrophobic site is introduced into a terminal of a polyester chain. This improves the affinity between the binder resin and the non-polar wax, which enables the non-polar wax to be sufficiently dispersed in the toner particle. As a result, it is possible to enhance the high-temperature offset resistance, which is a concern in a toner of a combination of a polyester resin and a monoester wax, and it is possible to realize a toner having excellent fixability both on the low temperature side and on the high temperature side of the fixable region.

In the present embodiment, a proportion of the hydrophobic site-introduced polyester resin in the amorphous polyester resin is preferably 15 mass % or more, more preferably 30 mass % or more, and still more preferably 50 mass % or more. When the hydrophobic site-introduced polyester resin is contained in the amorphous polyester resin in an amount equal to or more than the lower limit, the release agent can be sufficiently dispersed by the mechanism as described above. In addition, from the viewpoint of the high-temperature offset resistance and the heat-resistant storage stability of the toner, the proportion of the hydrophobic site-introduced polyester resin in the amorphous polyester resin is preferably 90 mass % or less, more preferably 80 mass % or less, and still more preferably 70 mass % or less.

The hydrophobic site is a site having a polarity lower than that of the polyester chain of the amorphous polyester resin, and exhibits an effect of enhancing the dispersibility of the non-polar wax as the release agent. Examples of the hydrophobic site include an aliphatic hydrocarbon chain and an aromatic hydrocarbon chain, and specifically, a polystyrene chain, a polyethylene chain, or a polypropylene chain is preferable. These hydrophobic sites have non-polar structures, respectively, as shown in FIG. 3, and thus, the polarity of the entire polymer can be sufficiently reduced by introducing the hydrophobic site into the polyester chain terminal, and the hydrophobic site functions as a crystal nucleating agent for the non-polar wax as described above.

In the present embodiment, the number of carbon atoms of the hydrophobic site is preferably 35 or more, and more preferably 40 or more. The polarity of the hydrophobic site-introduced polyester resin is affected by the number of carbon atoms of the hydrophobic site (that is, the chain length of the hydrophobic site). The number of carbon atoms of the polyol wax or the hydrocarbon wax as the non-polar wax is generally 20 or more, and in a case where the number of carbon atoms of the hydrophobic site is equal to or less than the number of carbon atoms of the non-polar wax, the function as the crystal nucleating agent may be insufficient. In addition, in a case where the number of carbon atoms of the hydrophobic site is less than the lower limit, the polarity of the polyester resin as a whole (the polarity of the binder resin as a whole) is not sufficiently low, and thus the effect of enhancing the dispersibility of the non-polar wax may also be insufficient. The number of carbon atoms of the hydrophobic site is preferably 70 or less, and more preferably 60 or less. An SP value of the resin decreases as the number of carbon atoms of the hydrophobic site increases. Thus, when the number of carbon atoms of the hydrophobic site exceeds the upper limit, the binder resin and the release agent are compatible with each other during melt-kneading, and the heat-resistant storage stability and the fixability may significantly deteriorate.

The polystyrene chain as the hydrophobic site can be introduced into the terminal of the polyester chain of the amorphous polyester resin by, for example, an addition polymerization reaction of a styrene monomer containing styrene or a styrene derivative such as α-methylstyrene or vinyltoluene as a main component with a bireactive monomer.

The bireactive monomer is preferably a compound having, in the molecule, at least one functional group selected from the group consisting of a hydroxyl group, a carboxy group, an epoxy group, a primary amino group, and a secondary amino group, preferably a hydroxyl group and/or a carboxy group, more preferably a carboxy group, and an ethylenically unsaturated bond, more preferably at least one selected from the group consisting of acrylic acid, methacrylic acid, fumaric acid, maleic acid, and maleic anhydride, and from the viewpoint of reactivity of the polycondensation reaction and the addition polymerization reaction, still more preferably at least one selected from the group consisting of acrylic acid, methacrylic acid, and fumaric acid.

The content of the styrene compound, preferably styrene, in raw material monomers of the styrene resin is preferably 50 mass % or more, more preferably 70 mass % or more, and still more preferably 75 mass % or more, from the viewpoint of storage stability under high humidity and productivity, and the content is preferably 95 mass % or less, more preferably 93 mass % or less, and still more preferably 90 mass % or less, from the viewpoint of the storage stability under high humidity and durability.

The amount of the bireactive monomer used is preferably 1 mol or more, and more preferably 2 mol or more, with respect to 100 mol of the total amount of alcohol components of the polyester resin, from the viewpoint of low-temperature fixability. From the viewpoint of enhancing dispersibility with the styrene-based resin and the polyester resin and improving durability of the toner, the amount of the bireactive monomer is preferably 30 mol or less, more preferably 20 mol or less, and still more preferably 10 mol or less.

The amount of the bireactive monomer used is preferably 1 part by mass or more, and more preferably 1.5 parts by mass or more, with respect to 100 parts by mass of the total amount of the raw material monomers of the styrene-based resin, from the viewpoint of low-temperature fixability. The content of the bireactive monomer is preferably 30 parts by mass or less, more preferably 20 parts by mass or less, and still more preferably 10 parts by mass or less, from the viewpoint of enhancing dispersibility with the styrene-based resin and the polyester resin and improving durability of the toner. Here, the total of the raw material monomers of the styrene-based resin includes a polymerization initiator.

The addition polymerization reaction of the styrene monomer can be carried out by a common method in the presence of a polymerization initiator such as dicumyl peroxide or di-t-butyl peroxide, a polymerization inhibitor, a crosslinking agent, or the like in an organic solvent or without a solvent. The temperature condition of the addition polymerization reaction is preferably 110° C. or higher, and more preferably 140° C. or higher, and is preferably 200° C. or lower, and more preferably 170° C. or lower.

In a case of introducing a polypropylene chain or an ethylene chain as the hydrophobic site, the styrene monomer only needs to be replaced with a polypropylene monomer or an ethylene monomer. Examples of the polypropylene monomer include polypropylene and a copolymer of propylene and another olefin. In a case of introducing a polyethylene chain, for example, a known production method by a metallocene catalyst using an ethylene monomer as a raw material can be adopted.

The SP value of the amorphous polyester resin containing the hydrophobic site-introduced polyester resin is preferably 10 or more and 11 or less and more preferably 10.3 or more and 10.9 or less. When the SP value is within the above range, a toner satisfying the requirement (D) is easily obtained. When the SP value is less than the lower limit, the compatibilization with the crystalline polyester resin proceeds excessively, and blocking resistance and hot offset resistance of the toner may be impaired. On the other hand, when the SP value exceeds the upper limit, the compatibility with the crystalline polyester resin is excessively lowered, and the low-temperature fixability may be insufficient.

### Crystalline Polyester Resin

In the toner particles according to the present embodiment, the crystalline polyester resin is dispersed in the amorphous polyester resin. The crystalline polyester resin is preferably composed of a linear saturated aliphatic polyester unit obtained through polycondensation between a carboxylic acid monomer including an aliphatic dicarboxylic acid having 9 to 22 carbon atoms as a main component and a polyhydric alcohol including an aliphatic diol having 2 to 10 carbon atoms as a main component.

The reaction conditions are the same as those for the production of a general polyester resin. For example, the crystalline polyester resin is obtained by reacting a carboxylic acid monomer and a polyhydric alcohol at a temperature in a range from 190° C. to 240° C. in a nitrogen gas atmosphere, in the presence of an esterification catalyst as necessary. The reaction ratio between the polyhydric alcohol and the carboxylic acid monomer is preferably from 0.83:1 to 1.3:1 in terms of an equivalent ratio between hydroxyl groups and carboxy groups [OH]:[COOH] from the viewpoint of the preservability of the toner.

The mole content of the dicarboxylic acid in the carboxylic acid monomer is preferably 90% or more and 100% or less. When the mole content of the dicarboxylic acid is low, the crystallization proportion and rate are reduced, and the toner aggregation resistance (difficulty of aggregation of toner) may be insufficient.

Examples of the aliphatic dicarboxylic acid having 9 to 22 carbon atoms include azelaic acid, sebacic acid, 1,10-decanedicarboxylic acid, and 1,18-octadecanedicarboxylic acid. The dicarboxylic acid monomer may include an ester-forming derivative of any of these aliphatic dicarboxylic acids. One of these dicarboxylic acid monomers may be used individually, or two or more may be used in combination.

In the synthesis of the crystalline polyester resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

Here, the mole content of the aliphatic diol having 2 to 10 carbon atoms in the polyhydric alcohol is preferably 80% or more and 100% or less.

Examples of the aliphatic diol having 2 to 10 carbon atoms include ethylene glycol, 1,4-butanediol, and 1,6-hexanediol. One of these diol monomers may be used individually, or two or more may be used in combination.

In the synthesis of the crystalline polyester resin, a polyol monomer containing three or more hydroxyl groups may be used together with the diol monomer. As the polyol monomer containing three or more hydroxyl groups, glycerol, trimethylolpropane, and the like can be used. One of these polyol monomers containing three or more hydroxyl groups may be used individually, or two or more may be used in combination.

The SP value of the crystalline polyester resin is preferably 9 or more and 10 or less, and more preferably 9.2 or more and 9.8 or less. When the SP value is within the above range, a toner satisfying the requirement (E) is easily obtained. When the SP value is less than the lower limit, the compatibility with the amorphous polyester resin is too low, and the durability may be insufficient. On the other hand, when the SP value exceeds the upper limit, the glass transition temperature (Tg) of the binder resin may be lowered, and the blocking resistance may be lowered.

### 4. Release Agent

The toner particle according to the present embodiment contains a non-polar wax as a release agent. Note that in the present disclosure, the non-polar wax means not only a wax having no polar group but also a wax having a very low polarity as a whole because polarities cancel out each other in the molecule. Specifically, in a case where a toner particle in which the binder resin is a polyester resin is prepared without using a hydrophobic site-introduced polyester resin according to Comparative Example 1 described below, and the average dispersion size of the wax is measured according to “Method of Measuring Average Dispersion Size of Release Agent in Toner Particle” described below, a wax having an average dispersion size of more than 6.5 m corresponds to the non-polar wax in the present disclosure.

Examples of such a non-polar wax include a polyol wax and a hydrocarbon wax. Some polyol waxes and hydrocarbon waxes have polar groups, but can be said to be substantially non-polar because the polarities cancel out each other in the molecule. On the other hand, examples of the wax that does not correspond to the non-polar wax include a monoester wax. The monoester wax has a polarity as the entire molecule because polarities molecule-structurally do not cancel out each other in the molecule.

The polyol wax means a wax in which an alcohol component is a polyol among ester waxes in which an alcohol and a long-chain fatty acid are ester-bonded. The number of carbon atoms of the long-chain fatty acid component is, for example, 10 or more and 30 or less. The alcohol component is not particularly limited as long as it is a polyol, that is, an aliphatic compound having two or more hydroxyl groups, and the number of carbon atoms of the aliphatic compound is, for example, 2 or more and 10 or less, and the number of functional groups is, for example, 2 or more and 8 or less.

The hydrocarbon wax means a highly hydrophobic wax mainly containing carbon and hydrogen, and specific examples thereof include polyethylene wax, polypropylene wax, microcrystalline wax, paraffin wax, and Fischer-Tropsch wax. The number of carbon atoms per molecule of the hydrocarbon wax is, for example, 15 or more and 45 or less.

One of these waxes may be used individually, or two or more thereof may be used in combination.

The polyol wax and the hydrocarbon wax as the release agent have a higher glass transition temperature and better thermal properties such as heat-resistant storage stability, as compared with a wax having a high polarity such as an ester wax. In the toner according to the present embodiment, such a release agent can be sufficiently dispersed in the toner particle, whereby both heat-resistant storage stability and fixability can be achieved.

The average particle size of the release agent in the toner particle according to the present embodiment is preferably 0.04 μm or more and 6.0 μm or less, more preferably 0.5 μm or more and 4.0 μm or less, and still more preferably 1.0 μm or more and 3.0 μm or less. In a case where the average dispersion size of the release agent exceeds the upper limit, the proportion of the release agent in the toner particle may increase, and the heat-resistant storage stability may deteriorate. In a case where the average dispersion size of the release agent is less than the lower limit, the release effect is not sufficiently exhibited during toner fixing, and the high-temperature offset resistance may deteriorate.

In the toner according to the present embodiment, the SP value of the release agent is preferably 8.4 or more and 9.4 or less, and more preferably 8.7 or more and 9.1 or less. When the SP value of the release agent is within the above range, a toner satisfying the above requirements (D) and (E) is easily obtained, and thus the release agent is easily sufficiently dispersed in the toner particle.

The content of the release agent in the toner particle according to the present embodiment is, for example, 0.5 mass % or more and 10 mass % or less, and is preferably 3 mass % or more and 8 mass % or less.

### 5. Colorant

The toner particles according to the present embodiment may include a colorant. For the colorant, an organic and/or inorganic pigment and dye of various types and/or colors that are commonly used in the field of electrophotography can be used, and examples thereof include black, white, yellow, orange, red, violet, blue, and green colorants.

Examples of the black colorant include carbon black, copper oxide, manganese dioxide, aniline black, activated carbon, nonmagnetic ferrite, magnetic ferrite, and magnetite.

Examples of the white colorant include zinc oxide, titanium oxide, antimony white, and zinc sulfide.

Examples of the yellow colorant include chrome yellow, zinc yellow, cadmium yellow, yellow iron oxide, mineral fast yellow, nickel titanium yellow, navel yellow, naphthol yellow S, Hansa yellow G, Hansa yellow 10G, benzidine yellow G, benzidine yellow GR, quinoline yellow lake, Permanent Yellow NCG, tartrazine lake, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, and C.I. Pigment Yellow 138.

Examples of the orange colorant include red chrome yellow, molybdenum orange, Permanent Orange GTR, pyrazolone orange, vulcan orange, Indanthrene Brilliant Orange RK, benzidine orange G, Indanthrene Brilliant Orange GK, C.I. Pigment Orange 31, and C.I. Pigment Orange 43.

Examples of the red colorant include red iron oxide, cadmium red, red lead, mercury sulfide, cadmium, Permanent Red 4R, Lithol Red, pyrazolone red, watching red, calcium salts, Lake Red C, Lake Red D, Brilliant Carmine 6B, eosin lake, Rhodamine Lake B, alizarin lake, Brilliant Carmine 3B, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, and C.I. Pigment 269.

Examples of the violet colorant include manganese violet, fast violet B, and methyl violet lake.

Examples of the blue colorant include iron blue, cobalt blue, alkali blue lake, victoria blue lake, phthalocyanine blue, metal-free phthalocyanine blue, partially chlorinated phthalocyanine blue, Fast Sky Blue, Indanthrene Blue BC, C.I. Pigment Blue 15, C.I. Pigment Blue 15:2, C.I. Pigment Blue 15:3, C.I. Pigment Blue 16, and C.I. Pigment Blue 60.

Examples of the green colorant include chrome green, chromium oxide, Pigment Green B, mica light green lake, Final Yellow Green G, and C.I. Pigment Green 7.

In the toner according to the present embodiment, one of the above colorants may be used alone, or two or more thereof may be used in combination. The combination may have different colors or the same color. The content of the colorant in the toner particle is preferably 0.1 mass % or more and 20 mass % or less, and more preferably 3 mass % or more and 15 mass % or less.

### 6. Other Internal Additives

The toner according to the present embodiment may contain an internal additive other than the above additives, as necessary. Examples of the internal additive other than the above additives include a charge control agent. The charge control agent is added to impart a preferable charging property to the toner. The charge control agent is not particularly limited, and charge control agents for positive charge control and negative charge control used in the field of electrophotography can be used.

Examples of a charge control agent for positive charge control include quaternary ammonium salts, pyrimidine compounds, triphenylmethane derivatives, guanidine salts, and amidine salts.

Examples of a charge control agent for negative charge control include metal-containing azo compounds, azo complex dyes, metal complexes and metal salts of salicylic acid and derivatives thereof (the metal is chromium, zinc, zirconium, or the like), organic bentonite compounds, and boron compounds.

One of these charge control agents may be used individually, or two or more thereof may be used in combination. The content of the charge control agent in the toner particle is preferably 0.5 mass % or more and 3 mass % or less.

### 7. External Additive

In the toner according to the present embodiment, an external additive may adhere to the surfaces of the toner particles described above. As the external additive, those commonly used in this field can be used, and examples thereof include inorganic particles such as silica, titanium oxide, silica carbide, aluminum oxide, and barium titanate, which have an average particle size of 7 nm or more and 200 nm or less. One of these inorganic particles may be used individually, or two or more thereof may be used in combination. Inorganic particles to which hydrophobicity is imparted by subjecting the surfaces of these inorganic particles to surface treatment with a hydrophobizing agent such as a silane coupling agent, a titanium coupling agent, or silicone oil are suitable because the decrease in electric resistance and charge amount in a high-humidity environment is small.

Examples of the silica particles as the external additive include silica particles commonly used in the art, for example, fumed silica particles obtained by burning silicon tetrachloride, dry-process silica particles such as arc process silica obtained by atomizing silica in a gas phase by high energy such as plasma, precipitated silica synthesized under an alkaline condition using a sodium silicate aqueous solution as a raw material, wet-process silica particles such as gel process silica synthesized under an acidic condition, colloidal silica particles obtained by making acidic silicic acid alkaline and polymerizing the acidic silicic acid, and sol-gel process silica particles obtained by hydrolyzing an organosilane compound.

As the silica particles serving as the external additive, commercially available hydrophobized silica particles may be used, or non-hydrophobized silica particles may be subjected to a treatment before use.

The titanium oxide particles as the external additive may be anatase-type titanium oxide particles or rutile-type titanium oxide particles. As a method of producing rutile-type titanium oxide particles, for example, there is a method described in JP 2001-26423 A, that is, a method in which an aqueous solution of titanium tetrachloride is hydrolyzed to prepare a fine titania sol having a rutile nucleus, and the sol is separated and then heat-treated to obtain titanium oxide particles. As a method of producing anatase-type titanium oxide particles, for example, there is a method described in JP 2000-10335 A, that is, a method in which a solution obtained by dissolving a raw material such as ilmenite ore in sulfuric acid is hydrolyzed, granulated, dried, and then calcined at a high temperature to obtain titanium oxide particles.

The content of the external additive is preferably 1 part by mass or more and 3 parts by mass or less with respect to 100 parts by mass of the toner particles. When the content of the external additive is less than the lower limit, it is difficult to impart the effect of enhancing fluidity. When the content of the external additive exceeds the upper limit, there is a concern that fixability may decrease.

### 8. Method of Producing Toner

The toner according to the present embodiment is produced by a pulverization method. In production of toner particles by the pulverization method, toner raw materials including a binder resin and an internal additive such as a release agent are dry-mixed in a mixer, and then melt-kneaded in a kneader to obtain a melt-kneaded product (melt-kneading step). Next, the obtained melt-kneaded product is cooled and solidified to obtain a solidified product, and the solidified product is pulverized by a pulverizer to obtain a finely pulverized product (fine pulverization step). Thereafter, the obtained finely pulverized product is subjected to particle size adjustment such as classification, as necessary, thereby obtaining toner particles (classification step). The toner particles and an external additive are mixed with a mixer to obtain a toner in which the external additive is attached to the surfaces of the toner particles (external addition step).

In the method of producing a toner according to the present embodiment, a shear rate at the time of melt-kneading the mixture of the toner raw materials in the melt-kneading step is preferably 4500 s⁻¹ or more and 25000 s⁻¹ or less, more preferably 5000 s⁻¹ or more and 20000 s⁻¹ or less, and still more preferably 7500 s⁻¹ or more and 15000 s⁻¹ or less. When the mixture of the toner raw materials is melt-kneaded, a shear stress is applied to the mixture, and the higher the shear stress, the stronger the kneading, thereby enhancing the degree of dispersion of each component. On the other hand, when the shear stress is equal to or more than the threshold value, polymer breakage occurs in the binder resin, and the molecular weight of the resin decreases, thereby deteriorating the low-temperature fixability and the heat-resistant storage stability of the toner.

In a toner in which a polyester resin having no hydrophobic site introduced therein and a non-polar wax are combined, it is difficult to sufficiently disperse the wax unless the toner is kneaded with a shear stress equal to or higher than the threshold value. In contrast, in the toner according to the present embodiment, the hydrophobic site-introduced polyester resin is used, and thus the dispersion of the wax can be chemically promoted, which allows the wax to be sufficiently dispersed even when kneading is performed with a low shear stress, and the occurrence of polymer breakage in the binder resin can be suppressed.

Note that the shear stress a in the melt-kneading of the mixture of the toner raw materials is represented by the following equation (1).

$$\begin{matrix}[ Equation 1 ] & \\ σ = \frac{2 η u \sqrt{Dh}}{hx} g ( θ ) & ( 1 )\end{matrix}$$

At this time, (shear stress)=(apparent viscosity)×(shear rate) holds, and thus the shear rate is represented by the following equation (2). Note that in the equations (1) and (2), η represents a viscosity, u represents a peripheral speed ratio of rolls, D represents a roll diameter, h represents a roll gap, and x represents a bank height.

$$\begin{matrix}[ Equation 2 ] & \\ ( Shear rate ) = \frac{2 u \sqrt{Dh}}{hx} g ( θ ) & ( 2 )\end{matrix}$$

As the mixer, the kneader, the pulverizer, and the classifier, known ones can be used. Examples of the mixer include a Henschel mixer (product name, available from Nippon Coke & Engineering Co., Ltd.), and a super mixer (product name, available from Kawata Mfg. Co., Ltd.). Specific examples of the kneader include single-screw or twin-screw extruders such as PCM-65/87 and PCM-30 (all product names, available from Ikegai Corp.), and open roll kneaders such as Kneadex (product name, available from Nippon Coke & Engineering Co., Ltd.). Examples of the pulverizer include a pulverizer that performs pulverization using a supersonic jet stream, such as a counter jet mill AFG (product name, available from Hosokawa Micron Corporation). Examples of the classifier include a rotary classifier such as a TSP separator (product name, available from Hosokawa Micron Corporation).

### EXAMPLES

Hereinafter, the toner of the present disclosure and the method of producing the same will be specifically described based on Examples and Comparative Examples.

### 1. Measurement and Calculation Method

### <Method of Calculating SP Value>

The SP value is calculated by the method described in “POLYMER ENGINEERING AND SCIENCE, February, 1974, Vol. 14, No. 2, ROBERT F. FEDORS. (pp. 147 to 154)” proposed by Fedors et al.

### <Method of Measuring Glass Transition Temperature of Resin>

A DSC curve is measured by heating 1 g of a sample at a temperature rising rate of 10° C./min in accordance with Japanese Industrial Standard (JIS) K7121-1987 using a differential scanning calorimeter (available from Seiko Instruments Inc. (current Hitachi High-Tech Science Corporation), model number: DSC220). In the obtained DSC curve, the temperature at the intersection of a straight line obtained by extending the baseline on the high temperature side of the endothermic peak corresponding to glass transition to the low temperature side and a tangent line drawn at a point where the gradient is the maximum with respect to the curve from the rising portion of the peak to the apex is defined as the glass transition temperature (Tg).

### <Method of Measuring Average Dispersion Size of Release Agent in Toner Particle>

The average dispersion size of the release agent in the toner particle was measured by the method described in “Evaluation Item 1: Evaluation of Dispersibility of Release Agent in Toner Particle” below.

### 2. Production of Toner

### <Preparation of Toner Raw Materials>

### —Preparation of Amorphous Polyester Resin α—

In a reaction vessel, 440 g (2.7 mol) of terephthalic acid, 235 g (1.4 mol) of isophthalic acid, 7 g (0.05 mol) of adipic acid, 554 g (8.9 mol) of ethylene glycol, and 0.5 g of tetrabutoxytitanate as a polymerization catalyst were placed. The mixture was reacted at 210° C. under a nitrogen stream for 5 hours while generated water and ethylene glycol were distilled off, and then reacted for 1 hour under a reduced pressure in a range from 5 mmHg to 20 mmHg. Then, 103 g (0.54 mol) of trimellitic anhydride was added, and the mixture was reacted under normal pressure for 1 hour. The mixture was then reacted under reduced pressure of 20 mmHg to 40 mmHg, and a resin was taken out at a predetermined softening point. The recovered ethylene glycol was 219 g (3.5 mol). The obtained resin was cooled to room temperature and then pulverized into particles. This was used as an amorphous polyester resin α.

### —Preparation of Hydrophobic Site (Polystyrene Chain, Number of Carbon Atoms: 50)-Introduced Polyester Resin A—

219 g (3.5 mol) of the amorphous polyester resin α 1500 g (15 mol) of a styrene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Then, the reaction solution was poured into an excess amount of methanol to obtain a hydrophobic site-introduced polyester resin A.

### —Preparation of Crystalline Polyester Resin β—

In a reaction vessel, 132 g (1.12 mol) of 1,6-hexanediol, 230 g (1.0 mol) of 1,10-decanedicarboxylic acid, and 3 g of tetrabutoxytitanate as a polymerization catalyst were placed, and the mixture was reacted at 210° C. under normal pressure for 5 hours while generated water was distilled off. Subsequently, the reaction was continued under a reduced pressure of 5 mmHg to 20 mmHg, and a resin was taken out when the acid value became 2 mg KOH/g or less. The obtained resin was cooled to room temperature and then pulverized into particles. This was used as a crystalline polyester resin β.

### Example 1

### <Production of Toner Particle>

### (Mixing and Melt-Kneading Step)

A toner particle (toner core) was produced using the following toner raw materials.

### Amorphous Polyester Resin

Hydrophobic site-introduced polyester resin A: 60 mass %
Amorphous polyester resin α: 23 mass %

### Crystalline Polyester Resin

Crystalline polyester resin β: 5 mass %

### Colorant

C.I. Pigment Red 269: 6 mass %

### Release Agent

Polyol wax (available from NOF Corporation, product name: WEP-8): 5 mass %

### Charge Control Agent

Salicylic acid-based compound (available from Orient Chemical Industries Co., Ltd., product name: Bontron E-84): 1 mass %

The above-mentioned materials were premixed for 5 minutes using a Henschel mixer (available from Mitsui Mining Co., Ltd. (current Nippon Coke & Engineering Co., Ltd.), model: FM20C) and then melt-kneaded using an open roll type continuous kneader (product name: MOS320-1800, available from Mitsui Mining Co., Ltd.).

As the setting conditions of the open roll, the shear rate was set to 10000 S⁻¹, the supply-side temperature of the heating roll was 130° C., the discharge-side temperature was 100° C., the supply-side temperature of the cooling roll was 40° C., and the discharge-side temperature was 25° C. As the heating roll and the cooling roll, rolls each having a diameter of 320 mm and an effective length of 1550 mm were used, and the gaps between the rolls on the supply side and the discharge side were both set to 1.1 mm. In addition, the rotation speed of the heating roll was set to 75 rpm, the rotation speed of the cooling roll was set to 65 rpm, and the supply amount of the toner raw materials was set to 5.0 kg/h.

### (Fine Pulverization Step)

The obtained melt-kneaded product was cooled with a cooling belt, and then coarsely pulverized using a speed mill having a cp 2 mm screen. The obtained coarsely pulverized product was finely pulverized using a jet-type pulverizer (available from Nippon Pneumatic Mfg. Co., Ltd., model: IDS-2) to obtain a finely pulverized product.

### (Classification Step)

The obtained finely pulverized product was classified using an elbow jet classifier (available from Nittetsu Mining Co., Ltd., model: EJ-LABO) to obtain toner particles. The obtained toner particles had an average particle size of 6.7 μm.

### <External Addition Step>

0.5 parts by mass of titanium oxide particles (product name: JMT-150, available from TAYCA CORPORATION, average primary particle size: 15 nm), and 1.2 parts by mass of silica particles (product name: RX200, available from Nippon Aerosil Co., Ltd., average primary particle size: 7 nm) were added to 100 parts by mass of the toner particles obtained in the classification step, and the mixture was stirred for 2 minutes using a Henschel mixer (available from Mitsui Mining Co., Ltd., model: FM20C) in which the tip speed of the stirring blade was set to 40 m/see to obtain a toner.

### <Developer Production Step>

The toner obtained in the external addition step and a resin-coated carrier are mixed in such a manner that the concentration of the toner with respect to the total amount of a two-component developer is 7%, thereby obtaining the two-component developer having a toner concentration of 7%.

### Examples 2 to 7, 9, 10, and 19, Comparative Examples 1 to 5

Toners and two-component developers of Examples 2 to 7, 9, 10, and 19 and Comparative Examples 1 to 5 were obtained in the same manner as in Example 1 except that the mass proportion of the hydrophobic site-introduced polyester resin in the amorphous polyester resin, the type of the release agent, and the shear rate during melt-kneading were changed as shown in Tables 1 and 2 below. Note that a polyester resin having only a different SP value from that of Example 1 was prepared in the same manner as the resin used in Example 1 except that the blending amount of the monomer was adjusted.

### Example 8

A toner and a two-component developer of Example 8 were obtained in the same manner as in Example 1 except that the hydrophobic site-introduced polyester resin to be used was changed to a hydrophobic site-introduced polyester resin B prepared by the following procedure.

### —Preparation of Hydrophobic Site (Polystyrene Chain, Number of Carbon Atoms: 40)-Introduced Polyester Resin B—

219 g (3.5 mol) of the amorphous polyester resin α, 1200 g (12 mol) of the styrene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Next, the reaction solution was poured into an excess amount of methanol to obtain the hydrophobic site-introduced polyester resin B.

### Example 11

A toner and a two-component developer of Example 11 were obtained in the same manner as in Example 1 except that the hydrophobic site-introduced polyester resin to be used was changed to a hydrophobic site-introduced polyester resin C prepared by the following procedure.

### —Preparation of Hydrophobic Site (Polystyrene Chain, Number of Carbon Atoms: 30)-Introduced Polyester Resin C—

219 g (3.5 mol) of the amorphous polyester resin α, 900 g (9 mol) of the styrene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Next, the reaction solution was poured into an excess amount of methanol to obtain the hydrophobic site-introduced polyester resin C.

### Example 12

A toner and a two-component developer of Example 12 were obtained in the same manner as in Example 1 except that the hydrophobic site-introduced polyester resin to be used was changed to a hydrophobic site-introduced polyester resin D prepared by the following procedure, and the mass proportion of the hydrophobic site-introduced polyester resin in the amorphous polyester resin and the shear rate during melt-kneading were changed as shown in Table 2.

### —Preparation of Hydrophobic Site (Polystyrene Chain, Number of Carbon Atoms: 20)-Introduced Polyester Resin D—

219 g (3.5 mol) of the amorphous polyester resin α, 600 g (6 mol) of the styrene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Next, the reaction solution was poured into an excess amount of methanol to obtain the hydrophobic site-introduced polyester resin D.

### Example 13

A toner and a two-component developer of Example 13 were obtained in the same manner as in Example 1 except that the hydrophobic site-introduced polyester resin to be used was changed to a hydrophobic site-introduced polyester resin E prepared by the following procedure, and the mass proportion of the hydrophobic site-introduced polyester resin in the amorphous polyester resin and the shear rate during melt-kneading were changed as shown in Table 2.

### —Preparation of Hydrophobic Site (Polystyrene Chain, Number of Carbon Atoms: 70)-Introduced Polyester Resin E—

219 g (3.5 mol) of the amorphous polyester resin α, 2100 g (21 mol) of the styrene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Next, the reaction solution was poured into an excess amount of methanol to obtain the hydrophobic site-introduced polyester resin E.

### Example 14

A toner and a two-component developer of Example 14 were obtained in the same manner as in Example 1 except that the hydrophobic site-introduced polyester resin to be used was changed to a hydrophobic site-introduced polyester resin F prepared by the following procedure, and the mass proportion of the hydrophobic site-introduced polyester resin in the amorphous polyester resin and the shear rate during melt-kneading were changed as shown in Table 2.

### Preparation of Hydrophobic Site (Polystyrene Chain, Number of Carbon Atoms: 110)-Introduced Polyester Resin F—

219 g (3.5 mol) of the amorphous polyester resin α, 3300 g (33 mol) of the styrene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Next, the reaction solution was poured into an excess amount of methanol to obtain the hydrophobic site-introduced polyester resin F.

### Examples 15 and 16

Toner and two-component developers of Examples 15 and 16 were obtained in the same manner as in Example 1 except that the hydrophobic site-introduced polyester resin to be used was changed to a hydrophobic site-introduced polyester resin G and the release agents shown in Table 2 were used.

### —Preparation of Hydrophobic Site (Polyethylene Chain, Number of Carbon Atoms: 50)-Introduced Polyester Resin G—

219 g (3.5 mol) of the amorphous polyester resin α, 420 g (15 mol) of an ethylene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Next, the reaction solution was poured into an excess amount of methanol to obtain the hydrophobic site-introduced polyester resin G.

### Examples 17 and 18

Toners and two-component developers of Examples 17 and 18 were obtained in the same manner as in Example 1 except that the hydrophobic site-introduced polyester resin to be used was changed to a hydrophobic site-introduced polyester resin H and the release agents shown in Table 2 were used.

### —Preparation of Hydrophobic Site (Polypropylene Chain, Number of Carbon Atoms: 50)-Introduced Polyester Resin H—

219 g (3.5 mol) of the amorphous polyester resin α, 1050 g (15 mol) of propylene monomer, 20 g (0.07 mol) of 4,4-azobis(4-cyanopentanoic chloride), and 600 g (11 mol) of acrylonitrile were dissolved in cyclohexane, and the mixture was heated and mixed at 90° C. for 12 hours to allow a reaction to proceed. Next, the reaction solution was poured into an excess amount of methanol to obtain the hydrophobic site-introduced polyester resin H.

The physical properties, types, and the like of the raw materials used in each of Examples and each of Comparative Examples are shown in Tables 1 and 2 below. Note that the paraffin wax as the hydrocarbon wax in Examples 2, 16, and 18 is “HNP-10PD” (product name) available from Nippon Seiro Co., Ltd., the Fischer-Tropsch wax as the hydrocarbon wax in Example 19 is “FNP-0090” (product name) available from Nippon Seiro Co., Ltd., and the monoester wax in Comparative Example 2 is “WE-22” (product name) available from NOF Corporation.

TABLE 1

| | | | | | | Difference | Difference | | | |
|---|---|---|---|---|---|---|---|---|---|---|
| | | | | | | in SP | in SP | | | |
| | Presence or | Presence | | | | value | value | Tg | Tg | |
| | absence of | or | SP | SP | SP | between | between | [° C.] | [° C.] | |
| | hydrophobic | absence | value | value | value | amorphous | crystalline | of | of | |
| | site- | of | of | of | of | PES and | PES and | binder | toner | ΔTg |
| | introduced | polarity | amorphous | crystalline | release | release | release | resin: | particle: | [° C.] |
| [symbol] | PES | of wax | PES | PES | agent | agent | agent | A | B | A − B |
| Example 1 | Present | Absent | 10.6 | 9.5 | 8.9 | 1.7 | 0.6 | 68 | 62 | 6 |
| Example 2 | Present | Absent | 10.6 | 9.5 | 8.8 | 1.8 | 0.7 | 68 | 62 | 6 |
| Example 3 | Present | Absent | 10.8 | 9.5 | 8.9 | 1.9 | 0.6 | 70 | 62 | 6 |
| Example 4 | Present | Absent | 10.4 | 9.5 | 8.9 | 1.5 | 0.6 | 65 | 64 | 6 |
| Example 5 | Present | Absent | 10.8 | 9.5 | 8.9 | 1.9 | 0.6 | 70 | 59 | 6 |
| Example 6 | Present | Absent | 10.6 | 9.5 | 8.9 | 1.7 | 0.6 | 68 | 64 | 10 |
| Example 7 | Present | Absent | 10.6 | 9.5 | 8.9 | 1.7 | 0.6 | 68 | 58 | 3 |
| Example 8 | Present | Absent | 10.6 | 9.5 | 8.9 | 1.7 | 0.6 | 68 | 65 | 6 |
| Example 9 | Present | Absent | 10.6 | 9.5 | 8.9 | 1.7 | 0.6 | 68 | 62 | 4 |
| Example 10 | Present | Absent | 10.6 | 9.5 | 8.9 | 1.7 | 0.6 | 68 | 64 | 6 |
| Example 11 | Present | Absent | 10.6 | 9.5 | 8.9 | 1.7 | 0.6 | 68 | 62 | 6 |
| Example 12 | Present | Absent | 10.9 | 9.5 | 8.9 | 2 | 0.6 | 68 | 62 | 6 |
| Example 13 | Present | Absent | 10.3 | 9.5 | 8.9 | 1.4 | 0.6 | 68 | 62 | 6 |
| Example 14 | Present | Absent | 9.6 | 9.5 | 8.9 | 0.9 | 0.6 | 68 | 62 | 6 |
| Example 15 | Present | Absent | 10.6 | 9.5 | 8.9 | 1.7 | 0.6 | 68 | 62 | 6 |
| Example 16 | Present | Absent | 10.6 | 9.5 | 8.8 | 1.8 | 0.7 | 68 | 62 | [symbol] |
| Example 17 | Present | Absent | 10.6 | 9.5 | 8.9 | 1.7 | 0.6 | 68 | 62 | [symbol] |
| Example 18 | Present | Absent | 10.6 | 9.5 | 8.8 | 1.8 | 0.7 | 68 | 62 | [symbol] |
| Example 19 | Present | Absent | 10.6 | 9.5 | 8.6 | 2 | 0.9 | 68 | 62 | [symbol] |
| Comparative | Absent | Absent | 10.9 | 9.5 | 8.9 | 2 | 0.6 | 68 | 62 | [symbol] |
| Example 1 | | | | | | | | | | |
| Comparative | Present | Present | 10.6 | 9.3 | 8.3 | 2.3 | 1 | 68 | 62 | [symbol] |
| Example 2 | | | | | | | | | | |
| Comparative | Present | Absent | 11.8 | 9.5 | 8.9 | 2.9 | 0.6 | 68 | 62 | [symbol] |
| Example 3 | | | | | | | | | | |
| Comparative | Present | Absent | 10.6 | 10.2 | 8.9 | 1.7 | 1.3 | 68 | 67 | [symbol] |
| Example 4 | | | | | | | | | | |
| Comparative | Present | Absent | 9.9 | 9.5 | 8.9 | 1 | 0.6 | 68 | 62 | [symbol] |
| Example 5 | | | | | | | | | | |

[symbol]

indicates data missing or illegible when filed

TABLE 2

| | | | Mass proportion | | | |
|---|---|---|---|---|---|---|
| | | | of hydrophobic | | Number of | |
| | | | site-introduced | | carbon | Average |
| | | | PES in amorphous | Shear | atoms of | dispersion size |
| | Hydrophobic | Wax type of | PES | rate | hydrophobic | of release |
| | site type | release agent | [wt %] | [s⁻¹] | site | agent |
| Example 1 | Polystyrene | Polyol wax | 60 | 10000 | 50 | 2.0 μm |
| Example 2 | Polystyrene | Paraffin wax | 60 | 10000 | 50 | 2.0 μm |
| | | (hydrocarbon | | | | |
| | | wax) | | | | |
| Example 3 | Polystyrene | Polyol wax | 20 | 10000 | 50 | 4.0 μm |
| Example 4 | Polystyrene | Polyol wax | 100 | 10000 | 50 | 0.05 μm |
| Example 5 | Polystyrene | Polyol wax | 10 | 10000 | 50 | 5.0 μm |
| Example 6 | Polystyrene | Polyol wax | 60 | 20000 | 50 | 2.0 μm |
| Example 7 | Polystyrene | Polyol wax | 60 | 5000 | 50 | 2.0 μm |
| Example 8 | Polystyrene | Polyol wax | 60 | 10000 | 40 | 2.0 μm |
| Example 9 | Polystyrene | Polyol wax | 60 | 30000 | 50 | 0.05 μm |
| Example 10 | Polystyrene | Polyol wax | 60 | 4000 | 50 | 4.0 μm |
| Example 11 | Polystyrene | Polyol wax | 60 | 10000 | 30 | 2.0 μm |
| Example 12 | Polystyrene | Polyol wax | 15 | 4500 | 20 | 6.5 μm |
| Example 13 | Polystyrene | Polyol wax | 100 | 25000 | 70 | 0.03 μm |
| Example 14 | Polystyrene | Polyol wax | 60 | 10000 | 110 | 1.2 μm |
| Example 15 | Polyethylene | Polyol wax | 60 | 10000 | 50 | 2.0 μm |
| Example 16 | Polyethylene | Paraffin wax | 60 | 10000 | 50 | 2.0 μm |
| | | (hydrocarbon | | | | |
| | | wax) | | | | |
| Example 17 | Polypropylene | Polyol wax | 60 | 10000 | 50 | 2.0 μm |
| Example 18 | Polypropylene | Paraffin wax | 60 | 10000 | 50 | 2.0 μm |
| | | (hydrocarbon | | | | |
| | | wax) | | | | |
| Example 19 | Polystyrene | Fischer- | 60 | 10000 | 50 | 2.0 μm |
| | | Tropsch wax | | | | |
| | | (hydrocarbon | | | | |
| | | wax) | | | | |
| Comparative | — | Polyol wax | 0 | 10000 | — | 2.0 μm |
| Example 1 | | | | | | |
| Comparative | Polystyrene | Monoester | 60 | 10000 | 50 | 2.0 μm |
| Example 2 | | wax | | | | |
| Comparative | Polystyrene | Polyol wax | 60 | 10000 | 50 | 7.0 μm |
| Example 3 | | | | | | |
| Comparative | Polystyrene | Polyol wax | 60 | 10000 | 50 | 2.0 μm |
| Example 4 | | | | | | |
| Comparative | Polystyrene | Polyol wax | 60 | 10000 | 50 | 0.02 μm |
| Example 5 | | | | | | |

### 3. Evaluation

<Evaluation Item 1: Evaluation of Dispersibility of Release Agent in Toner Particle>

The toner produced is embedded in an epoxy resin, and is subjected to surface projection with an ultramicrotome (available from Reichert, product name: Ultracut N) to produce a sample. The obtained sample is gas-phase stained using a 0.5% aqueous solution of ruthenium tetroxide (VIII), and observed with a scanning transmission electron microscope (available from Hitachi High-Technologies Corporation, model: S-4800). A considerable number (about 50) of particles of the release agent were randomly extracted from the electron micrograph data, and image analysis was performed with image analysis software (product name: A-zo Kun, available from Asahi Kasei Engineering Corporation) to determine the average dispersion size of the release agent. Based on the average dispersion size, the dispersibility of the release agent was evaluated according to the following criteria.
⊚ (Excellent): The average dispersion size of the release agent is 0.05 μm or more and 2.0 μm or less.
◯ (Good): The average dispersion size of the release agent is more than 2.0 μm and 4.0 m or less.
Δ (Marginal): The average dispersion size of the release agent is more than 4.0 μm and 6.5 μm or less, or less than 0.05 μm.
x (Poor): The average dispersion size of the release agent is more than 6.5 μm.

### <Evaluation Item 2: Evaluation of High-Temperature Offset Resistance (Fixability on High Temperature Side of Fixable Region)>

A fixed image was formed with a two-component developer using a commercially available copy machine (available from Sharp Corporation, model: MX-5100FN) modified for evaluation. First, a sample image including a solid image (a rectangle 20 mm long and 50 mm wide) was formed as an unfixed image on a recording sheet (PPC sheet available from Sharp Corporation, model: SF-4AM3). At this time, the adhesion amount of the toner to the recording sheet in the solid image was adjusted to 0.5 mg/cm².

Next, a fixed image was prepared using a hard roller fixing apparatus. The fixing process speed was set to 140 mm/sec, and the temperature of the fixing roller was raised from 140° C. in increments of 5° C. to determine the highest temperature at which high-temperature offset did not occur. Note that “high-temperature offset” means that the toner is not fixed to the recording paper at the time of fixing but remains attached to the fixing belt, and is attached to the recording paper after the fixing belt makes one round. From the obtained results, the “high-temperature offset resistance” was evaluated according to the following criteria.
⊚ (Excellent): The highest temperature is 195° C. or higher.
◯ (Good): The highest temperature is 185° C. or higher and less than 195° C.
Δ (Marginal): The highest temperature is 170° C. or higher and less than 185° C.
x (Poor): The highest temperature is lower than 170° C.
   <Evaluation item 3: Evaluation of Heat-Resistant Storage Stability>

10 g of the toner was placed in a 100-mL glass bottle, and was left to stand in a thermostatic chamber at a temperature of 50° C. for 24 hours. The heated toner was placed on a three-stage mesh screen (mesh openings of 250 μm, 150 μm, and 75 μm from the upper stage), and after performing a screening operation for 1 minute with an ultrasonic screen, the degree of aggregation was calculated. Note that the calculation equation of the degree of aggregation is as follows, and in the equation, G is the degree of aggregation, W is the mass of the sample, W₁ is the amount of residue on the upper-stage mesh, W₂ is the amount of residue on the middle-stage mesh, and W₃ is the amount of residue on the lower-stage mesh.

$$G = ( {W}_{1} + 0.6 \times {W}_{2} + 0.2 \times {W}_{3} ) \times 100 / W$$

Based on the calculated degree of aggregation, the heat-resistant storage stability of the toner was evaluated according to the following criteria.
⊚ (Excellent): The highest temperature is 195° C. or higher.
◯ (Good): The highest temperature is 185° C. or higher and less than 195° C.
Δ (Marginal): The highest temperature is 170° C. or higher and less than 185° C.
x (Poor): The highest temperature is lower than 170° C.

### <Comprehensive Evaluation>

Based on the results of the above three evaluation items, comprehensive evaluation was made according to the following criteria.
⊚ (Excellent): All evaluation items are “⊚”. Available.
◯ (Good): The lowest evaluation among all the three evaluation items is “◯”. Available.
Δ (Marginal): The lowest evaluation among all the three evaluation items is “Δ”. Available.
x (Poor): There is “x” even in one evaluation item. Unusable.

TABLE 3

| | Evaluation | | | |
|---|---|---|---|---|
| | | High- | Heat- | |
| | | temperature | resistant | |
| | | offset | storage | Comprehensive |
| | Dispersibility | resistance | stability | assessment |
| Example 1 | ⊚ | ⊚ | ⊚ | ⊚ |
| Example 2 | ⊚ | ⊚ | ⊚ | ⊚ |
| Example 3 | ◯ | ◯ | ◯ | ◯ |
| Example 4 | ⊚ | ◯ | ◯ | ◯ |
| Example 5 | Δ | ◯ | ◯ | Δ |
| Example 6 | ◯ | ◯ | ⊚ | ◯ |
| Example 7 | ◯ | ◯ | ◯ | ◯ |
| Example 8 | ◯ | ◯ | ◯ | ◯ |
| Example 9 | ⊚ | Δ | ◯ | Δ |
| Example 10 | Δ | ◯ | Δ | Δ |
| Example 11 | ◯ | ◯ | Δ | Δ |
| Example 12 | Δ | ◯ | Δ | Δ |
| Example 13 | Δ | Δ | ⊚ | Δ |
| Example 14 | ⊚ | Δ | Δ | Δ |
| Example 15 | ⊚ | ⊚ | ⊚ | ⊚ |
| Example 16 | ⊚ | ⊚ | ⊚ | ⊚ |
| Example 17 | ⊚ | ⊚ | ⊚ | ⊚ |
| Example 18 | ⊚ | ⊚ | ⊚ | ⊚ |
| Example 19 | ⊚ | ◯ | ◯ | ◯ |
| Comparative | X | X | X | X |
| Example 1 | | | | |
| Comparative | ◯ | X | Δ | X |
| Example 2 | | | | |
| Comparative | Δ | Δ | X | X |
| Example 3 | | | | |
| Comparative | Δ | Δ | X | X |
| Example 4 | | | | |
| Comparative | Δ | X | X | X |
| Example 5 | | | | |

Table 3 shows the evaluation results of Examples and Comparative Examples. According to Table 3, the toners of Examples 1 to 19, which were toners having toner particles each containing a binder resin and a release agent and satisfying the following requirements (A) to (F), were able to sufficiently disperse the release agent in the toner particles and achieved both fixability and heat-resistant storage stability.
(A) The binder resin contains an amorphous polyester resin and a crystalline polyester resin.
(B) The amorphous polyester resin contains a hydrophobic site-introduced polyester resin in which a hydrophobic site is introduced into a terminal of a polyester chain.
(C) The release agent is a non-polar wax.
(D) A difference in SP value between the amorphous polyester resin and the release agent is 1 or more and 2 or less.
(E) The difference in SP value between the crystalline polyester resin and the release agent is 1 or less.
(F) When the glass transition temperature of the binder resin is A [° C.] and the glass transition temperature of the toner particle is B [° C.], A-B is 2 or more and 12 or less.

On the other hand, in Comparative Examples 1 to 5, which did not satisfy these requirements, at least one of the evaluations of the dispersibility of the release agent, the high-temperature offset resistance, and the heat-resistant storage stability was inferior to that of Examples.

Note that Comparative Example 1 is an example in which the amorphous polyester resin contains no hydrophobic site-introduced polyester resin and does not satisfy the requirement (B), Comparative Example 2 is an example in which a monoester wax which is a release agent not satisfying the requirement (C) is used, Comparative Example 3 is an example in which a polyol wax not satisfying the requirements (D) and (F) is used, Comparative Example 4 is an example in which a polyol wax not satisfying the requirement (E) is used, and Comparative Example 5 is an example in which a polyol wax not satisfying the requirement (F) is used.

It is found that Example 3 and the like in which the amorphous polyester resin contains 15 mass % or more of the hydrophobic site-introduced polyester resin are particularly excellent in the evaluation of the dispersibility of the release agent as compared with Example 5 in which the content is less than the lower limit.

It is found that Example 8 and the like in which the number of carbon atoms of the hydrophobic site in the hydrophobic site-introduced polyester resin is 35 or more are particularly excellent in the evaluation of the heat-resistant storage stability as compared with Example 11 in which the number of carbon atoms is less than the lower limit.

It is found that Example 1 and the like in which the average dispersion size of the release agent in the toner particle is 0.04 m or more are particularly excellent in the evaluation of the high-temperature offset resistance as compared with Example 13 in which the average dispersion size is less than the lower limit. In addition, it is found that Example 1 and the like in which the average dispersion size of the release agent in the toner particle is 6.0 m or less are particularly excellent in the evaluation of the heat-resistant storage stability as compared with Example 12 in which the average dispersion size exceeds the upper limit.

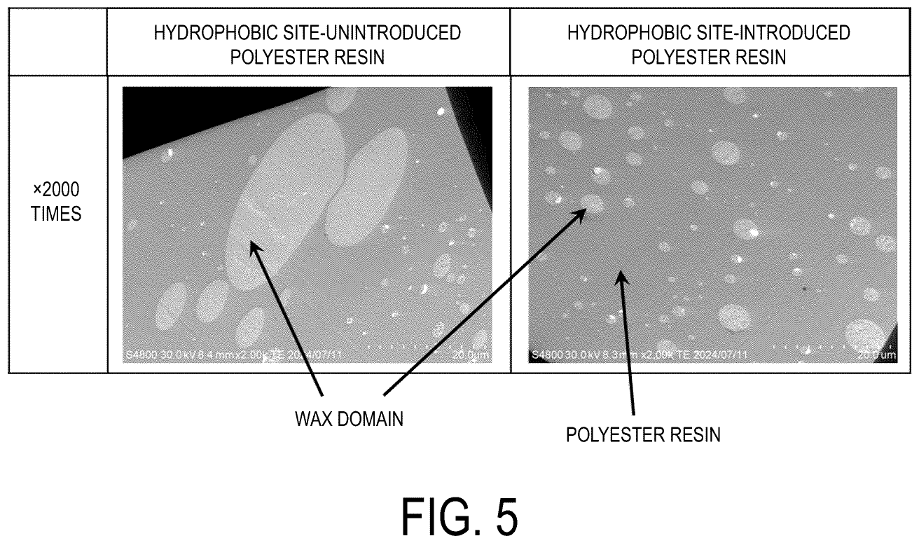

FIG. 5 provides SEM images of cross-sections of toner particles each using a polyol wax as the release agent. Specifically, the image on the left side of FIG. 5 is an SEM image of a cross-section of a toner particle in which the amorphous polyester resin contains no hydrophobic site-introduced polyester resin, and corresponds to Comparative Example 1. The image on the right side of FIG. 5 is an SEM image of a cross-section of a toner particle in which the amorphous polyester resin includes a hydrophobic site-introduced polyester resin, and corresponds to Examples. From the SEM images shown in FIG. 5, it is found that the release agent is present in a sufficiently dispersed state by the amorphous polyester resin containing the hydrophobic site-introduced polyester resin.

The embodiments disclosed herein are illustrative in all respects and are not the basis for a limited interpretation. Accordingly, the technical scope of the present disclosure is not to be construed by the foregoing embodiments only, and is defined based on the description of the claims. In addition, meanings equivalent to the range of the claims and all changes made within the range are included.

### REFERENCE SIGNS LIST

T1 Toner particle
W1 Wax domain
10 Amorphous polyester resin
11 Polyester chain
12 Hydrophobic site

1. A toner comprising a toner particle containing a binder resin and a release agent, wherein
the binder resin contains an amorphous polyester resin and a crystalline polyester resin,
the amorphous polyester resin contains a hydrophobic site-introduced polyester resin in which a hydrophobic site is introduced into a terminal of a polyester chain,
the release agent is a non-polar wax,
a difference in SP value between the amorphous polyester resin and the release agent is 1 or more and 2 or less,
a difference in SP value between the crystalline polyester resin and the release agent is 1 or less, and
when a glass transition temperature of the binder resin is A [° C.] and a glass transition temperature of the toner particle is B [° C.], A-B is 2 or more and 12 or less.

2. The toner according to claim 1,
wherein the amorphous polyester resin contains the hydrophobic site-introduced polyester resin in an amount of 15 mass % or more.

3. The toner according to claim 1,
wherein the hydrophobic site is a polystyrene chain, a polyethylene chain, or a polypropylene chain.

4. The toner according to claim 1,
wherein the non-polar wax is a polyol wax or a hydrocarbon wax.

5. The toner according to claim 1,
wherein the hydrophobic site has 35 or more carbon atoms.

6. The toner according to claim 1,
wherein the release agent in the toner particle has an average dispersion size of 0.04 m or more and 6.0 m or less.

7. A method of producing the toner according to claim 1, the method comprising melt-kneading of melt-kneading a mixture of toner raw materials containing the binder resin and the release agent to obtain a melt-kneaded product,
wherein a shear rate at which the mixture is melt-kneaded in the melt-kneading is 4500 s⁻¹ or more and 25000 s⁻¹ or less.
